(19) United States
(12) Patent Application Publication
(10) Pub. No.: US 2009/0026309 A1
(43) Pub. Date: Jan. 29, 2009

(54) Aircraft

(75) Inventor: Michael SCHWARZ, Salem (DE)

Correspondence Address: CROWELL & MORING LLP;INTELLECTUAL PROPERTY GROUP, P.O. BOX 14300, WASHINGTON, DC, 20044-4300, US

(73) Assignee: EADS Deutschland GmbH, Ottonbrunn (DE)

(21) Appl. No.: 12/056,463

(22) Filed: Mar. 27, 2008

(30) Foreign Application Priority Data
Mar. 28, 2007 (DE) 102007015373.4-22

(51) Int. Cl. B64C 1/00

(52) U.S. Cl. 244/62; 244/119

(57) ABSTRACT

The invention relates to an aircraft having a first propulsion unit with an air inlet above the fuselage of the aircraft and a second propulsion unit with an air inlet below the fuselage of the aircraft, the fuselage of the aircraft having recesses for receiving the propulsion units which are arranged such that the first and the second propulsion unit are arranged above one another in the plane set by the longitudinal and vertical axis of the aircraft. The propulsion unit comprises an engine, a housing having an air inlet, devices for the releasable fastening of the propulsion unit to the fuselage of the aircraft as well as devices for establishing a releasable connection of electric supply and data lines as well as fuel lines between the propulsion unit and the fuselage of an aircraft.

This application claims the priority of German patent document 10 2007 015 373.4-22, filed Mar. 28, 2007, the disclosure of which is expressly incorporated by reference herein.

The invention relates to an aircraft having a plurality of propulsion units, and to a propulsion unit for an aircraft.

When multiple propulsion units are used in an aircraft, they are normally arranged symmetrically on opposite sides of a vertical longitudinal plane of the aircraft, for example, in engine pods at the wing (such as the Airbus A380), on pylons laterally at the fuselage (such as the Learjet 60 Windrose), or arranged side-by-side in the fuselage (such as the Eurofighter). For aircraft with a landing gear, this configuration ensures the free floating capacity in the tail region required for rotation during the start.

Unmanned aircraft normally use the same propulsion configuration; however, for a catapult take-off, the requirement of a free floating capacity in the tail region does not exist. Unmanned aircraft may be used, for example, as target designation drones (such as the Do-DT 35 of EADS Co.) or reconnaissance drones (such as the CL 289 of EADS Co.).

The aerodynamic characteristics of unmanned aircraft vary considerably and additional differences exist with respect to speed and maximum payload.

Published U.S. Patent Application No. US 2006/0054739 A1 discloses an aircraft with a plurality of turbines that are combined in engine pods. The shape of the engine pods is selected corresponding to their intended use on the fuselage of the aircraft.

U.S. Pat. No. 3,285,175 discloses a rocket with circularly arranged propulsion units, while UK Patent No. 924,078 discloses an aircraft that has two laterally arranged propulsion units at the tail. In addition, the aircraft has two propulsion units arranged in the interior of the aircraft, one such propulsion unit having an air inlet leading to the top side of the aircraft fuselage, and the other having an air inlet leading to the bottom side of the aircraft fuselage.

One object of the present invention is to provide an aircraft having improved aerodynamic characteristics.

Another object of the invention is to provide a propulsion unit for such an aircraft.

These and other objects and advantages are achieved by the aircraft according to the invention, which has recesses in the fuselage, which accommodate the propulsion units. The propulsion units are arranged one above the other in a plane defined by the longitudinal and vertical axes (also called roll axis and yaw axis). In this case, the air inlet of one propulsion unit is situated above the fuselage of the aircraft, while the air inlet of the other is below the fuselage of the aircraft. Such an arrangement of propulsion units, such as engines, above one another instead of side-by-side enhances directional stability without changing the position of the center of mass, because the projected area is enlarged in the transverse direction of the aircraft in the tail region.

A propulsion unit according to the invention comprises the engine, a housing with an air inlet, devices for releasably fastening the propulsion unit at the fuselage of an aircraft and devices for releasably connecting electric supply lines, data lines and fuel lines between the propulsion unit and the fuselage of the aircraft.

The propulsion unit is expediently constructed as a module, which ensures rapid installation and removal of the propulsion unit. In addition, modular construction permits a simple adaptation of the aircraft to different mission tasks. For example, propulsion units with efficient engines require the same amount of fuel on board, and can achieve higher speeds than propulsion units with less efficient engines. On the other hand, by means of the latter, it becomes possible to achieve a mission task with a high range requirement.

Modular propulsion units, can also be tested and maintained separately from the aircraft, so that it is available for further mission tasks, and the elapsed ground times of the aircraft are thereby significantly reduced.

### BRIEF DESCRIPTION OF THE DRAWINGS

FIG. 1 is a sectional view of a first embodiment of an aircraft according to the invention; and

FIG. 2 is a sectional view of a second embodiment of an aircraft according to the invention.

### DETAILED DESCRIPTION OF THE DRAWINGS

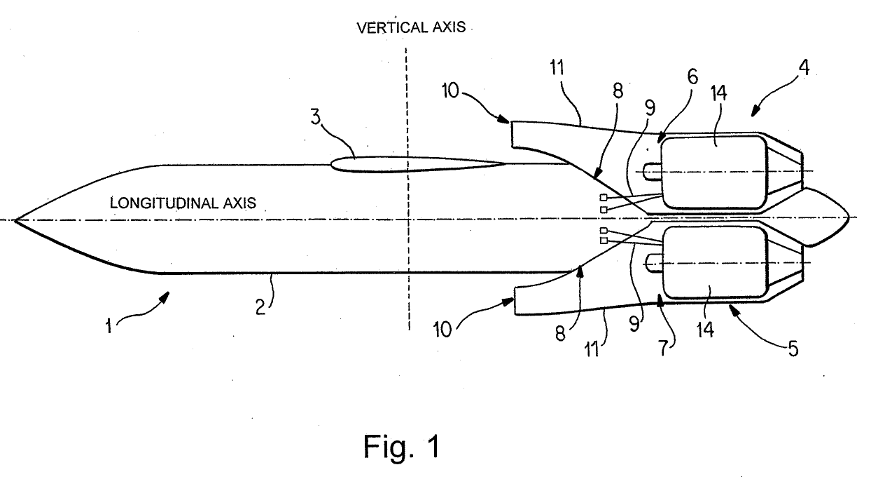

FIG. 1 illustrates an aircraft according to the invention in a first embodiment, which includes a fuselage 2, wings 3 and of propulsion units 4, 5. For example, corresponding to a shoulder-wing monoplane, the wings 3 are arranged flush with the upper edge of the fuselage. However, depending on the demands made on the aircraft, the wings 3 may be arranged below the fuselage corresponding to a monoplane with low-set wings, or at medium height of the fuselage corresponding to a mid-wing monoplane, or above the fuselage corresponding to a monoplane with high-set wings.

The two propulsion units 4, 5, which are constructed as modules, are advantageously identical, so that it is possible to exchange them at the positions 6 and 7, without causing changes in the flight characteristics of the aircraft 1 during the operation. In other words, a propulsion unit 4, 5 can be connected with the fuselage 2 of the aircraft 1 optionally in position 6 or position 7.

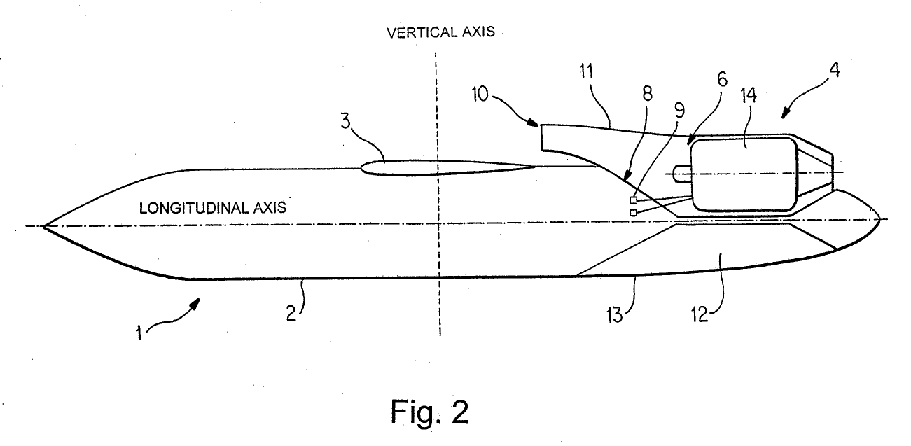

According to the invention, recesses 12 (FIG. 2) for receiving the propulsion units 4, 5 are formed in the fuselage 2 of the aircraft 1, thereby ensuring a small cross-section perpendicular to the longitudinal axis and thus a low aerodynamic drag in the intended use of the aircraft 1.

The two propulsion units 4, 5 are advantageously arranged symmetrically with respect to a plane that is perpendicular to the vertical axis of the aircraft (that is a plane is expediently defined by the transverse and longitudinal axes).

Each propulsion unit 4, 5 consists essentially of a housing 11 with an air inlet opening 10 in the flying direction, an engine 14 and devices 8, 9 for connecting the propulsion unit 4, 5 to the fuselage 2 of the aircraft 1.

According to the invention, the air inlet 10 of one propulsion unit 4 is situated above the fuselage 2 of the aircraft 1, while the air inlet 10 of the other propulsion unit 5 is situated below the fuselage 2. The air inlet 10 is expediently integrated in the housing 11 of the propulsion units 4, 5, its geometry 10 depending on the application case. It can thereby be integrated directly in the propulsion unit 4, 5 and is therefore independent of the fuselage 2 of the aircraft 1.

The two propulsion units 4, 5 are advantageously detachably connected with the fuselage 2 of the aircraft 1. For this purpose, devices 8 for holding the propulsion units 4, 5 and devices 9 for establishing a connection of electric supply and data lines as well as fuel lines between the fuselage 2 of the aircraft 1 and the propulsion units 4, 5 are provided on the fuselage 2 of the aircraft 1.

In the following, the expression “a releasable connection between the fuselage 2 of the aircraft 1 and a propulsion unit 4, 5” means that, for separating the propulsion unit 4, 5 from the fuselage 2 of the aircraft, only the connection devices 8, 9 need be opened. Essentially, the detachment of the propulsion unit 4, 5 should not be accompanied by the removal of possible fuselage parts.

The devices 8 for holding the propulsion units 4, 5 may, for example, be guide rails having a snap-type lock constructed at the intended position of the propulsion unit. A propulsion unit 4, 5 is placed on this rail and is moved into the intended position (not shown), where it engages, for example, by means of a snap-type lock. For releasing this connection, lever devices (not shown), for example, are provided, by means of which the lock can be unlocked.

Expediently, corresponding devices are provided on the propulsion unit 4, 5 and at the fuselage 2 of the aircraft 1, which devices engage in one another and lock for establishing a releasable connection.

Bush-plug connections (not shown) are expediently provided to connect electric supply and data lines as well as fuel lines between the fuselage 2 of the aircraft 1 and a propulsion unit 4, 5. The bush-plug arrangement is expediently designed such that a mutual locking takes place in the intended position of the propulsion unit 4, 5. The bush arrangement is expediently situated on the propulsion side, and the plug arrangement is situated on the fuselage side. Here also, lever devices (not shown), for example, are provided for releasing the connection, by means of which lever devices, the bush-plug connection can be unlocked.

Other arrangements are of course also possible for releasably connecting the lines and electric lines.

The 2-engine configuration designed for high performance can also be adapted to mission tasks with a high service life and additional payload by removal of a propulsion unit 4, 5. Thus, as another embodiment of the invention, FIG. 2 shows a variant in which a propulsion unit (propulsion module) was replaced by an empty module 13. For example, the propulsion unit 5 on the underside of the aircraft 1 from FIG. 1 was replaced by the empty module 13. The latter may, for example, provide space for additional electric components for reconnaissance missions. However, the empty module 13 may also just be used as a covering of the recess 12.

Generating sets (batteries), control components, fuel tanks, a paraglide and/or drogue parachute as well as additional payload in the form of electric components for carrying out an intended mission of the aircraft as a reconnaissance or target designation drone, for example, are accommodated inside the fuselage 2 of the aircraft.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. An aircraft having a first propulsion unit with an air inlet above a plane that is longitudinal and horizontal to a fuselage of the aircraft during horizontal flight and a second propulsion unit with an air inlet below said longitudinal horizontal plane; wherein:
the fuselage of the aircraft has recesses for receiving the propulsion units;
the recesses are arranged such that the first and second propulsion units are arranged above one another in a plane defined by roll and yaw axes of the aircraft.

2. The aircraft according to claim 1, wherein the first and second propulsion units are substantially identical to each other.

3. The aircraft according to claim 2, wherein the first and the second propulsion units are arranged symmetrically with respect to a plane which is perpendicular to the vertical axis of the aircraft during horizontal flight.

4. The aircraft according to claim 1, wherein the first and second propulsion units are releasably connected with the fuselage of the aircraft by a fastening device.

5. The aircraft according to claim 4, wherein:
devices for holding the propulsion units and devices for establishing a connection of electric supply and data lines as well as fuel lines between the fuselage of the aircraft and the propulsion units are provided on the fuselage;
the fastening device and the connection device on the fuselage of the aircraft each lock into a device provided on the propulsion unit for establishing a releasable mutual connection.

6. The aircraft according to claim 5, wherein the fastening device comprises a guide rail.

7. The aircraft according to claim 5, wherein:
a bush-plug coupling is provided for establishing a releasable connection of electric supply lines, data lines and fuel lines between the propulsion unit and the fuselage of the aircraft;
a plug of the bush-plug coupling is fastened to the aircraft;
a bush arrangement of the bush-plug coupling is provided on the propulsion unit; and
the bush arrangement locks into the plug when the propulsion unit is in an installed position on the fuselage.

8. A propulsion unit for an aircraft, said propulsion unit comprising:
an engine;
a housing having an air inlet;
fastening devices for releasably fastening the propulsion unit on the fuselage of the aircraft; and
devices for establishing a releasable connection of electric supply lines, data lines and fuel lines between the propulsion unit and the fuselage of the aircraft; wherein,
the fastening device on the propulsion unit engage with and lock into a device provided on the fuselage of the aircraft for establishing a releasable connection.

9. The propulsion unit according to claim 6, wherein the fastening device is a snap-type lock.

10. The propulsion unit according to claim 6, wherein:
a bush-plug coupling is provided for establishing a releasable connection of electric supply lines, data lines and fuel lines between the propulsion unit and the fuselage of the aircraft; and
a bush arrangement is fastened to the propulsion unit into which a plug arrangement locks which is provided on the aircraft when the propulsion unit is in an installed position.

11. An aircraft comprising:
a fuselage;
first and second recesses formed in a body of said fuselage, which recesses are arranged opposite and above one another in a plane defined by roll and yaw axes of the aircraft; and
at least one engine mounted in one of said first and second recesses; wherein,
said at least one engine is of modular construction and is releasably and interchangeably attachable in either of said recesses; and
electric and fuel lines are coupled between said fuselage and said at least one engine, via releasable couplers.
